(19) United States
(12) Patent Application Publication
(10) Pub. No.: US 2008/0092042 A1
(43) Pub. Date: Apr. 17, 2008

(54) ELECTRONIC DISSEMINATION OF SOLICITATIONS

(75) Inventor: Scott Haug, Seattle, WA (US)

Correspondence Address: BLACK LOWE & GRAHAM, PLLC, 701 FIFTH AVENUE, SUITE 4800, SEATTLE, WA, 98104, US

(73) Assignee: Jobster Incorporated, Seattle, WA (US)

(21) Appl. No.: 11/829,565

(22) Filed: Jul. 27, 2007

Related U.S. Application Data
(60) Provisional application No. 60/820,583, filed on Jul. 27, 2006.

(51) Int. Cl. G06F 3/048

(52) U.S. Cl. 715/700

(57) ABSTRACT

A computer-implementable method includes providing a web-based primary graphical user interface (GUI) within which a user can post a job listing, the primary GUI operable to include multiple web-based secondary GUIs associated with respective job-listing posting services.

### PRIORITY CLAIM

The present application claims priority from U.S. Provisional Application No. 60/820,583 filed Jul. 27, 2006, which is herein incorporated by reference as if fully set forth herein.

### FIELD OF THE INVENTION

Embodiments of the invention relate generally to computer services and, more particularly, to web-based job and other classified ad posting services.

### BACKGROUND OF THE INVENTION

In computerized job-posting endeavors, an entity wishing to list a job on multiple services must inconveniently visit and use a respective different website for each such service.

### SUMMARY OF THE INVENTION

In an embodiment of the invention, a computer-implementable method includes providing a web-based primary graphical user interface (GUI) within which a user can post a job listing, the primary GUI operable to include multiple web-based secondary GUIs associated with respective job-listing posting services.

### DETAILED DESCRIPTION OF THE PREFERRED EMBODIMENT

Jobster's time saving Direct Post enables you to post your jobs to, for example, Craigslist*, GoogleBase, and/or America's Job Bank in one easy step. Using this single-click feature, you can now manage multiple site postings and/or responses from within the Jobster service.

Publish your hiring needs instantly to multiple sites

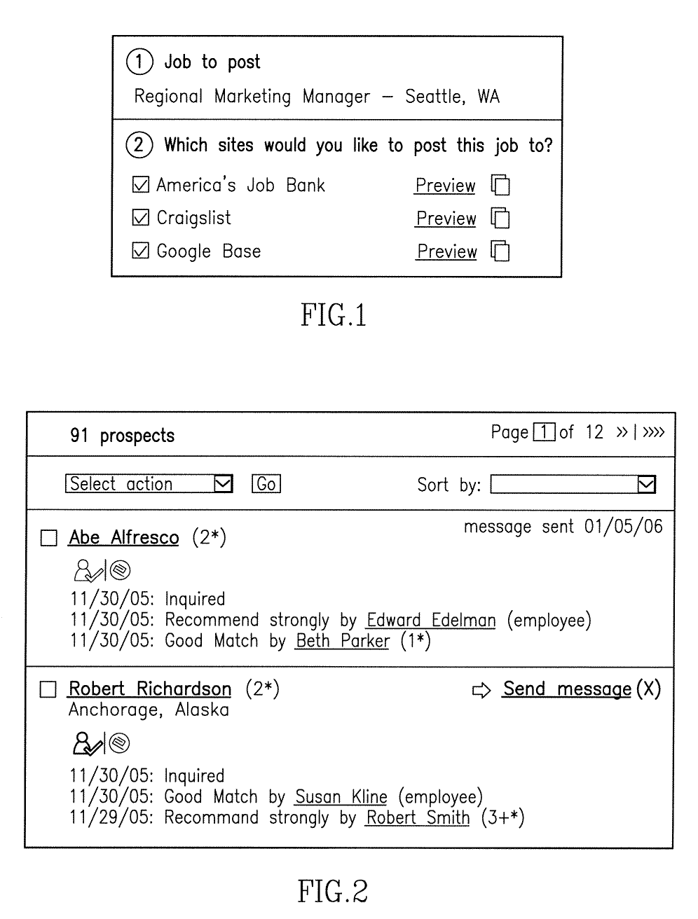

Save time. As shown in FIG. 1, there's no need to set up and manage multiple posting accounts.

Manage incoming responses in a single place

As shown in FIG. 2, Jobster captures inquiries and delivers them to your prospect management list.

Measure your results in real-time

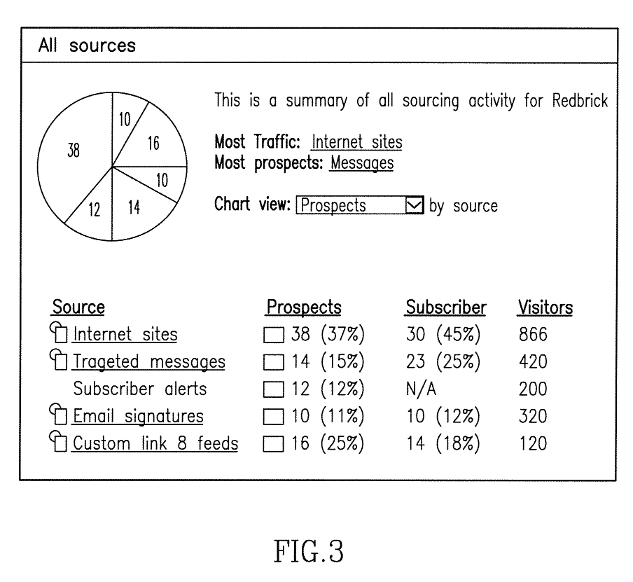

As shown in FIG. 3, report on the source effectiveness of your postings, and see how each channel compares. Give your team visibility to make better recruiting decisions.

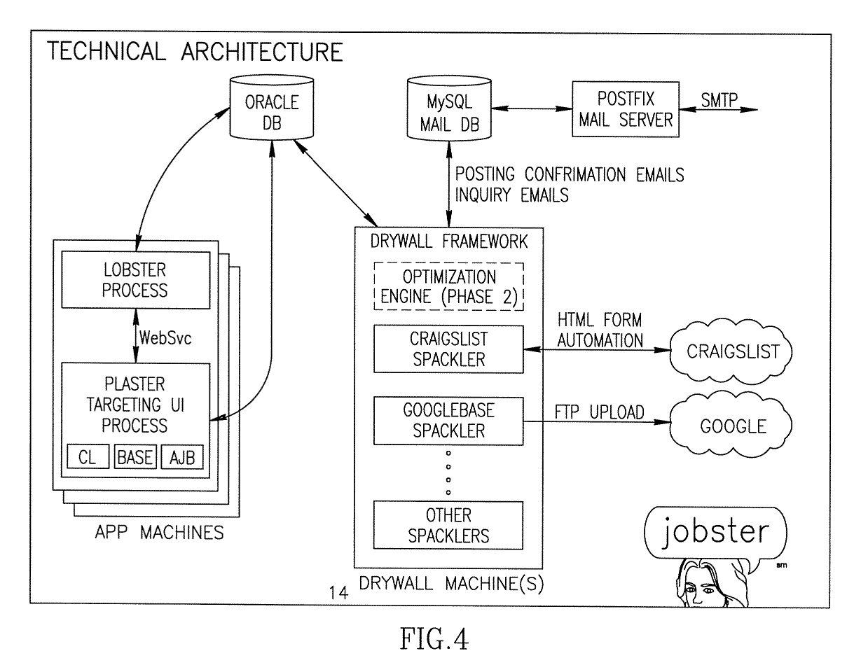

FIG. 4 illustrates and architecture Overview of DirectPost and Targeting

What is Targeting?

For GB customers, offer short-term results from Jobster
Advertise jobs to active and/or passive jobseekers
Target ads to specific audiences to result in high ROI even without referrals
Jobster's advantages are:
Recruiter audience generates fresh, high quality jobs for placement
Specialization in job postings: Simplify & automate online advertising; normalize pricing models

Support of full Jobster product is available to recruiters and/or jobseekers

Targeting Project Phases
Phase 1: Automated Job Distribution (R11)

Distribute to free job boards for active job seekers

Build foundation infrastructure & app integration

Craigslist free cities, Google Base, America's Job Bank, sponsored jobs on Jobster

No transactional charges

Simplified UI for GB customers
Phase 2: Targeted Ads (R12)

Active and/or Passive jobseekers with targeted placement

Paid venues: Paid CL, Google AdWords, AdBrite, Federated Media, Facebook

Feedback mechanism for what ads & targeting is effective
Phase 3: Targeting Distribution Networks (R13++)

Refinement of pricing model

Targeting Terminology

Destination: place to post targeted ads

Examples: Craigslist, Google Base

Distribution: targeted posting, mapping job opportunity to a destination

A new type of channel

Example: single job posting on Craigslist

Spackler: plug-in module that does the work of creating distributions on destinations.

Plaster & Drywall: Frameworks that contain spacklers

R11 Scenarios
P1: New GB account

Jobster needs to offer short term value to the GB customer by generating prospects quickly and without significant up-front time investment.
Login to account. Simplified UI leads directly to job−>post workflow
Create a job
Post job
Prospects arrive from posting, Recruiter manages prospects
P1: Existing SA customer

Targeting is new way to source, relieves complexity and tedium of manually posting jobs
Login, notice new capability for targeting
Jobs can be managed and/or filtered based on posting status
Use sources page to determine effectiveness of different channels
P2: Manage targeting

Job is posted, but may need finer grained control over posting
Post a job with targeting
Receive a flood of low-quality resumes from Craigslist posting as compared to Google Base. Recruiter edits options for job and takes down Craigslist posting.

R11 Job Distribution Features
Lobster app integration

Targeting action on jobs

Customize targeting

Filter by targeting in job list

Sources page integration & reports
Simplified landing pages—integrate with referral wizard work
Tracking of unique information for Distributions
Impression tracking
Spacklers:

Craigslist, Google Base, AJB
Simplified overall UI for GB customers

Architectural Guiding Principles
Extensible framework for new Destinations

Backend: Common framework for scheduling & management

Frontend: Dynamically compose the UI list of Destinations & Destination-specific preview & options UI
New Destination Deployment: Use code & full build

New Destinations can arrive maximum 1-2 per month

Adding Destination entirely through configuration may not be feasible due to heterogeneity of Destinations
Spackler Updating

Some Spacklers can be fragile due to forms & email scraping, e.g. Craigslist

May need support for rev'ing to work around minor breaks

Separate Spacklers from full lobster application to support separate deployment

Spackler Functionality
Frontend

Validation, e.g. known editorial guidelines, free vs. paid cities

UI rendering for preview

UI representation of options that the recruiter can specify
Backend

Formatting Opportunities into whatever format and/or schema a Destination may require

Namespace translation, e.g. available cities, job categories

Posting protocol, e.g. custom web service APIs, scheduled FTP file uploads, web form scraping and/or automation, email scraping

Maintenance of postings: updates, deletes

Reporting of failures

Flag needed spackler updates

Plaster & Drywall
Plaster—frontend framework

Scale like Lobster: Deployed as separate process on lobster front-end machines

Communicate through db, server side includes, and possibly web service interface
Drywall

Support scale-out—its own cloud of machines

Use ‘greedy’ scheduling model
Drywall pool machine polls for available Distribution or email to process
Grabs & marks distribution as being processed

Quartz scheduling framework used when needed by a particular spackler, e.g. Google Base

Database Extensions
Distributions table: extends channel

distribution_id

who created

when created

opportunity_id

impressions

distribution type−>what type of spackler

distribution_config−>blob

status−>used by Drywall to handle scheduling
Distribution_config: spackler-specific prop bag, provide resistance to db schema changes for minor spackler rev
Status: Pending|Spackling|Finished, etc
Impressions may be tracked in aggregated form
Spackler-specific tables may be added on spackler-by-spackler basis

Craiglist Spackler Process Details
Select correct city URL
Automate 6 webforms to post
Wait for confirmation email to unique email address
Scrape CL's confirmation URL from email
Automate CL confirmation form
Return to confirmation form for deletion
We can build a “fake” CL proxy for testing

Google Base Spackler Details
Google Base has manual posting or bulk upload
Bulk upload
Annotated RSS 1.0, 2.0 or Atom file
Custom field values for Google Base categories
Uploaded through FTP
Google blocks uploads more or less than once every few hours

Targeting Plug-in Architecture for Spacklers

Overview

In the targeting framework, Spacklers can be distributed and/or installed using a plug-in mechanism. This document describes thoughts around how these plug-ins can work, including run-time discovery, versioning, packaging, and the interfaces that can be exposed.

Related Links

Several existing Java plugin mechanisms were investigated as part of this process. Below are links to some of these efforts.
Eclipse Plug-in Architecture
Java Module System
Replaceable Components and the Service Provider Interface
JAR Service Provider Mechanism
ServiceRegistry (javadoc)

Options

The R13 launch of the targeting framework established following options for Spackler plugins:
The plugin may be deployable as a JAR
The Spackler implementation(s) provided by this plugin may be discoverable at runtime by targeting host environment without additional configuration
The plugin may provide versioning and/or vendor information to the host environment
The plugin may expose a factory for creating Spackler instances that extend the Spackler base class

Additionally, while plugins may eventually be buildable and/or packaged externally from the actual lobster project itself, this wasn't a requirement of the R13 launch.

SPI and ImagelO

Ultimately, the plugin mechanism provided by Java's own JAR Service Provider mechanism (SPI) was deemed optionally advantageous as a basis for Spackler plugins. Service provider classes may be detected at run time by means of meta-information in the JAR files containing them. It had the added optional advantage of being readily available (it ships standard with J2SE) and sufficiently documented. Finally, J2SE provides the ImageIO registry , an easily emulated, full fledged example of this plugin mechanism in action. As such, the targeting plugin framework for Spacklers follows the ImageIO SPI model closely.

While the targeting framework may not use the IIORegistry directly, it may use the ServiceRegistry class as a base class for its own TargetingRegistry. While ServiceRegistry is part of the javax.imageio package, it is applicable as a generic registry for service provider instances.

SpacklerSpi

In the SPI model, service provider classes are intended to be lightweight and quick to load. Implementations of these interfaces may avoid complex dependencies on other classes and/or on native code. Among their functions is to serve as a factory for the more heavyweight service instances.

SpacklerSpi is the service provider interface for Spacklers. The SpacklerSpi instance for a plugin provides additional information, such as the spackler name, version, and/or vendor data. But among its functions is to contruct Spackler instances as necessary, via its createSpacklerInstance method. The SpacklerSpi is solely responsible for creating and/or initializing Spackler instances, but the Spackler's lifecycle is managed by the calling code.

The SpacklerSpi instances themselves are not created in a vaccuum. When used by the Jobster Employer Application, they may be managed by the RegisterSpacklerManager class, which can initialize newly-created SpacklerSpi instances using the Spring application context .

XmlApplicationContextSpacklerSpi

For Spacklers that may have greater creation and/or initialization requirements, the XmlApplicationContextSpacklerSpi provides more advanced spackler creation functionality. Subclasses of this SPI can define their own Spring application context using Spring 2.0's XML syntax. This context can be made a child context of the client's own application context, making all Spring-managed application services (such as the data source, transaction manager, and/or scheduler) available to this spackler's context. By default, this SPI can define its context using the file “spackler.xml”. When requested, this SPI can create Spackler instances by retrieving the bean named “spackler” from its application context.

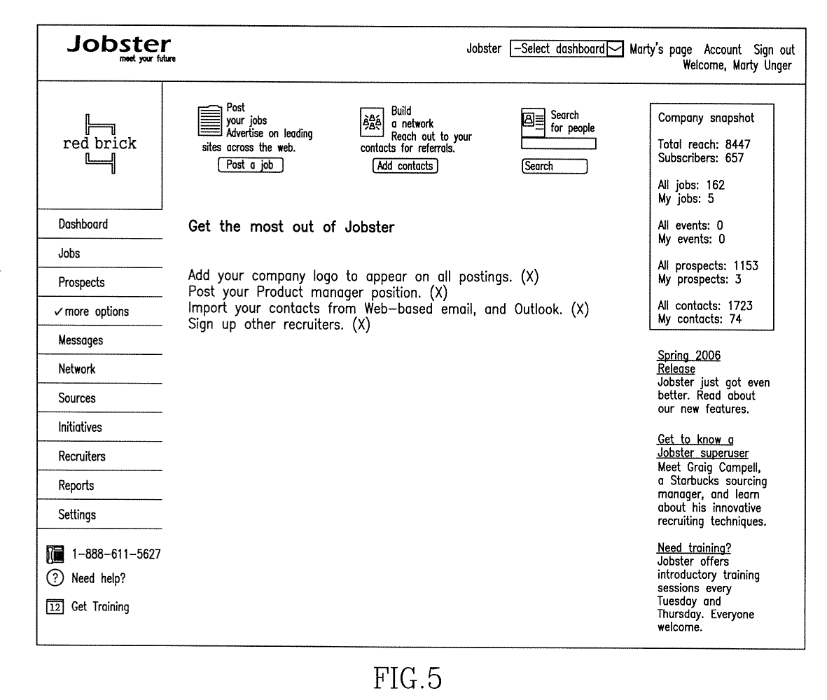

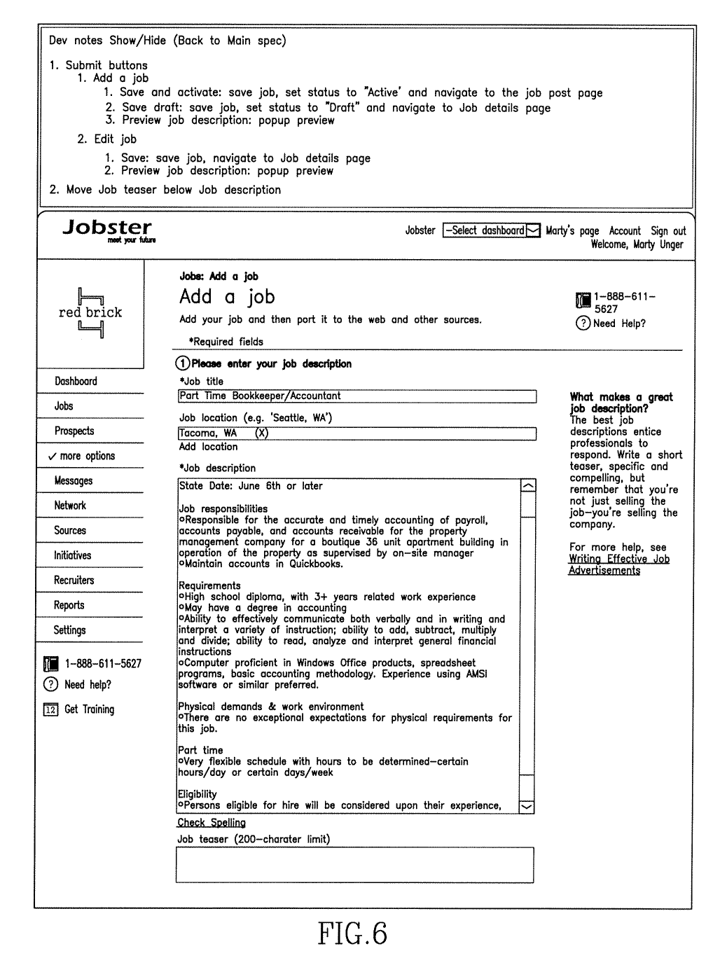

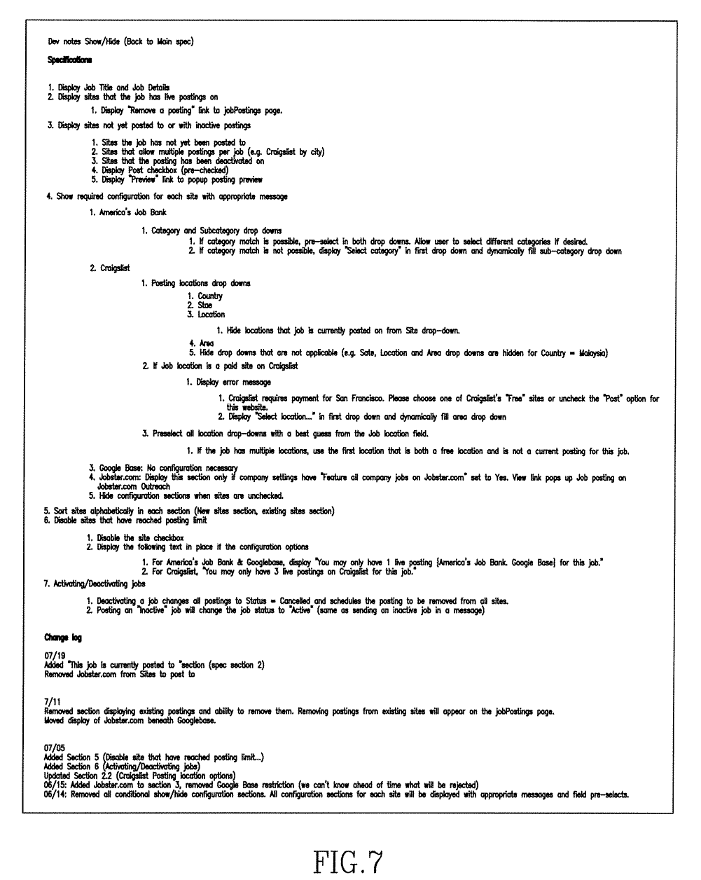

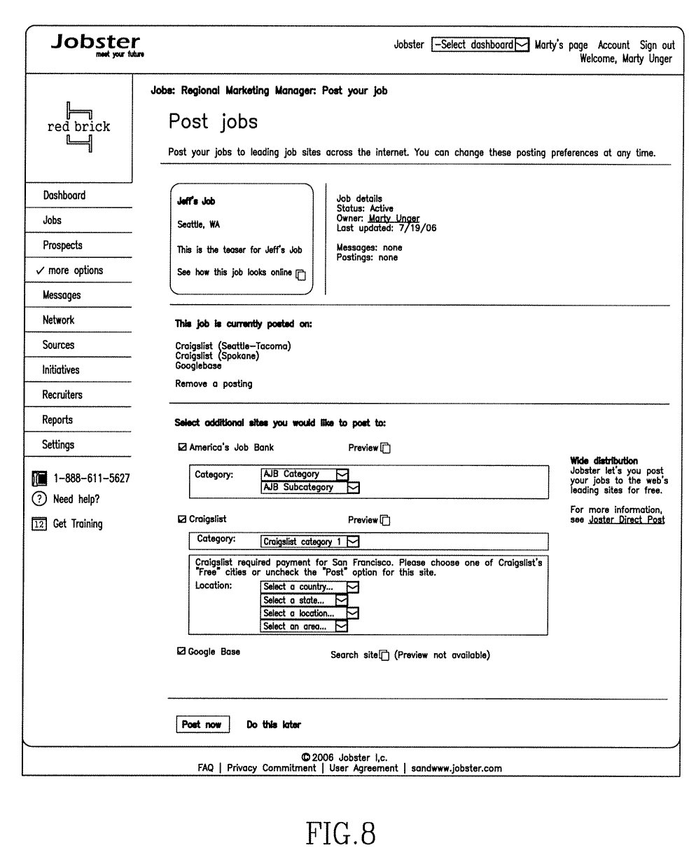

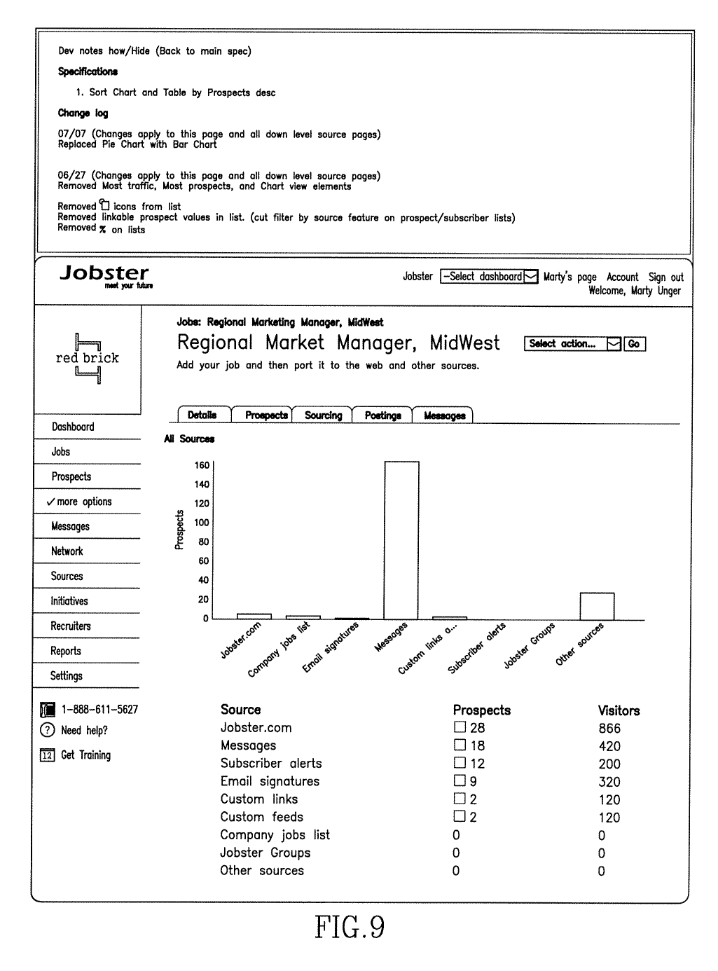

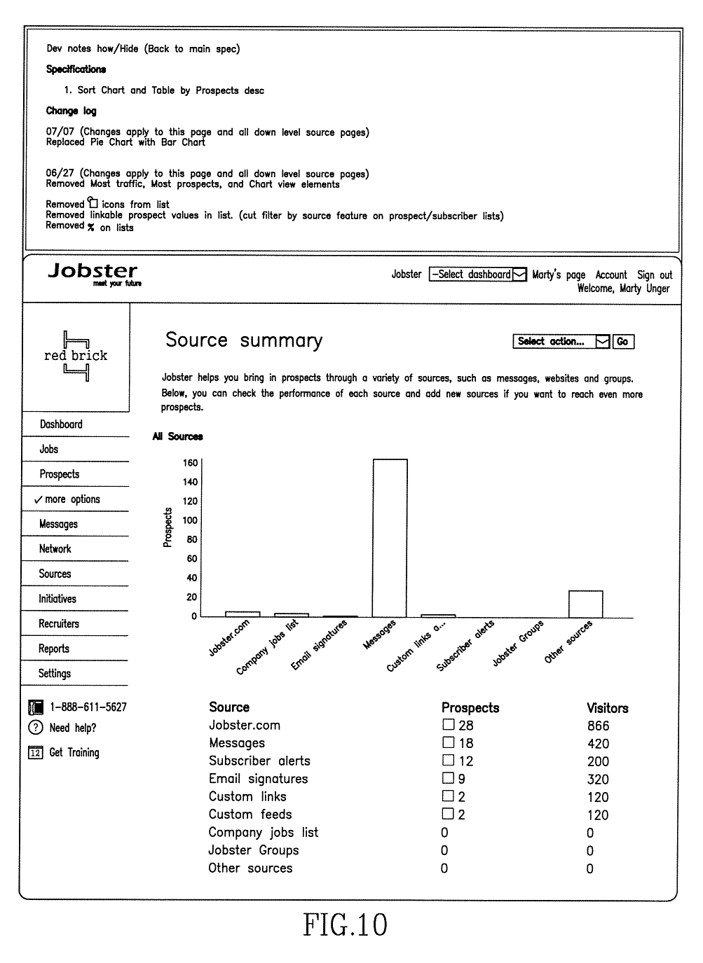

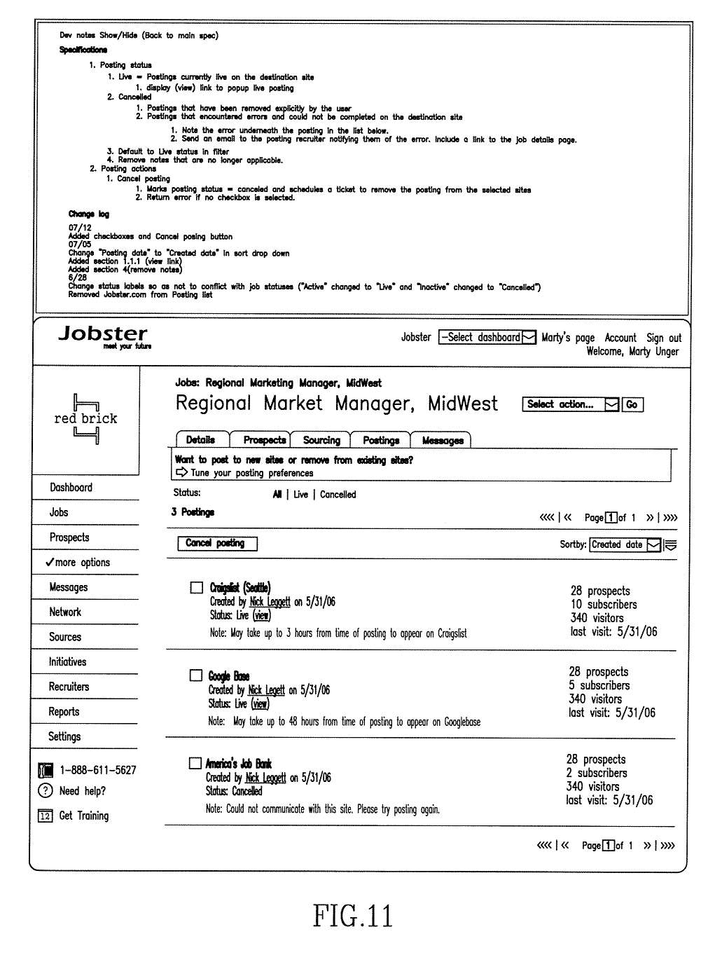

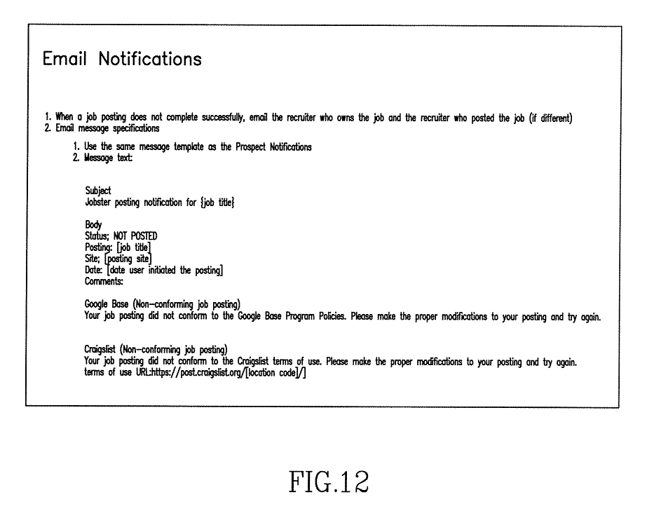

FIGS. 5-12 illustrate DirectPost UI Screenshots and Specifications

While a preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

Embodiments of the invention in which an exclusive property or privilege is defined as follows:

1. A method comprising the steps of:
providing a web-based primary graphical user interface (GUI) within which a user can post a job listing, the primary GUI operable to include multiple web-based secondary GUIs associated with respective job-listing posting services.
